(19) United States
(12) Patent Application Publication
(10) Pub. No.: US 2025/0368831 A1
(43) Pub. Date: Dec. 4, 2025

(54) HYBRID POLYURETHANE-EPOXY WATERBORNE PRIMER AND COATINGS SYSTEM FORMED THEREFROM

(71) Applicant: SWIMC LLC, Cleveland, OH (US)

(72) Inventors: Liang LIANG, Twinsburg, OH (US); Gordon A. BORU, Cleveland, OH (US)

(21) Appl. No.: 19/217,366

(22) Filed: May 23, 2025

Related U.S. Application Data
(60) Provisional application No. 63/653,342, filed on May 30, 2024.

(51) Int. Cl. C09D 5/00; C08G 59/40; C09D 5/02; C09D 163/00; C09D 175/04

(52) U.S. Cl. CPC C09D 5/002; C08G 59/4028; C09D 5/02; C09D 163/00; C09D 175/04; C08G 2270/00

(57) ABSTRACT

A 3K primer coating composition containing a waterborne epoxy resin dispersion; a polyurethane dispersion; and a curing component containing a non-isocyanate crosslinker component, and optionally further containing an isocyanate crosslinker component, is provided, along with a primer coating formed from the composition. The coating includes a network of crosslinked epoxy resin regions and crosslinked polyurethane resin regions. The crosslinked epoxy resin regions include units from the epoxy resin dispersion and the isocyanate. The crosslinked polyurethane resin regions include units from the polyurethane dispersion and the non-isocyanate crosslinker component.

### CROSS REFERENCE TO RELATED APPLICATIONS

The present invention is related to, and claims priority to, U.S. Provisional Application Ser. No. 63/653,342, filed May 30, 2024, the contents of which are hereby incorporated by reference in their entirety.

### TECHNICAL FIELD

The present invention relates to a hybrid polyurethane-epoxy waterborne primer formed upon a reaction between epoxy resin dispersion, a polyurethane dispersion, and a non-isocyanate crosslinker component; coatings systems from therefrom; and methods of making the same.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent borne primers is one of the critical issues prompting interest in a switch to waterborne primers.

Low VOC and zero emission are significant advantages of waterborne coatings, providing a motivation to develop various waterborne coating solutions. Many efforts have been addressed to replace solvent borne primers with waterborne primers. However, past efforts have resulted in poor performance, particularly in the area of anticorrosion, thus restricting the use of waterborne primers, especially for refinishing vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy. Some primers are further defined as etch primers, which may etch the surface to which it is applied to further promote adhesion between the etch primer and the surface.

### SUMMARY OF THE INVENTION

Accordingly, one object of the present invention is to provide hybrid waterborne primer comprising a polymer network of crosslinked epoxy resin regions and crosslinked polyurethane resin regions that has a combination of properties not otherwise attainable with a single polymer based waterborne primer.

A further object of the invention is to provide hybrid waterborne primer compositions formed upon mixing three parts. The first part comprises a waterborne epoxy resin dispersion; the second part comprises a polyurethane dispersion; and the third part comprises a non-isocyanate crosslinker component, and optionally further comprises an isocyanate. The polyurethane dispersion may comprise carboxyl groups. The epoxy resin dispersion may comprise hydroxyl groups. The non-isocyanate crosslinker component may comprise a carbodiimide compound, a polycarbodiimide compound, an aziridine compound, a polyaziridine compound, or a combination thereof. Upon mixing the first part, the second part, and the third part, a hybrid polymer network comprising crosslinked epoxy resin regions and isocyanate-free crosslinked polyurethane resin regions is formed. This hybrid waterborne primer composition may be applied to a substrate and provides comparable and/or improved adhesion and anti-corrosion properties, among other properties, when compared to conventional solvent borne primers.

A further object of the invention is to provide a coatings system over a substrate, particularly a metal substrate, comprising a waterborne etch primer layer over the substrate and a hybrid polyurethane-epoxy waterborne primer layer over the waterborne etch primer layer. The waterborne etch primer layer may include a hybrid epoxy-polysiloxane etch primer composition. The coatings system has a combination of properties not otherwise attainable with a conventional solvent borne coating systems.

Another object of the present invention is to provide a method for the production of the hybrid polyurethane-epoxy waterborne primer compositions of the present invention, and methods for its use.

These and other objects of this invention, alone or in combination, have been satisfied by the discovery of a hybrid polyurethane-epoxy waterborne primer comprising a hybrid polymer network of crosslinked epoxy resin regions and crosslinked polyurethane resin regions. The hybrid polyurethane-epoxy waterborne primer and coatings systems made therefrom will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a schematic of some embodiments of a hybrid polyurethane-epoxy waterborne primer comprising a network of crosslinked epoxy resin regions and crosslinked polyurethane regions free of isocyanates.

FIG. 2 illustrates a schematic of some embodiments of the formation of crosslinked polyurethane via a reaction of a non-isocyanate curing agent (such as a polycarbodiimide) and a carboxyl group on a polyurethane dispersion (PUD).

FIG. 3 illustrates a schematic of some embodiments of a crosslinked epoxy formed from a reaction between an epoxy resin dispersion and an aliphatic isocyanate.

FIG. 4 illustrates a schematic of some embodiments of the formation of crosslinking in an epoxy resin developed by catalyst of quaternary ammonium salt functional groups on a PUD.

FIG. 5 illustrates a schematic of some embodiments of an etch primer layer comprising crosslinked polysiloxane bonded to a substrate.

FIG. 6 illustrates a schematic of some embodiments of a hybrid epoxy-polysiloxane etch primer composition formed from a reaction between silane having an amine functional group and epoxy resin dispersion.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl.” For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, water soluble oligomers and polymers, and the like.

The term “(co)polymer” as used herein includes both homopolymers (polymers containing units from a single monomer) and copolymers (polymers containing units from two or more different monomers), unless otherwise specifically stated. Copolymers also include star, block, and grafting polymer.

The term “crosslinker” or “crosslinking component” as used herein refers to at least one molecule capable of forming a covalent linkage between polymers or between two different regions of the same polymer.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

Within the context of the present invention, the term “hybrid primer” includes, but is not limited to, semi-and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, and the like. Crosslinked networks can also be developed by thermal activation, redox reactions, gamma irradiation, and/or UV-irradiation.

Within the context of the present invention, the term “waterborne” is intended to mean that the polymeric components are in an aqueous medium. In certain embodiments, waterborne coatings provide one or more of the following advantages: low toxicity and non-flammability due to low VOC levels and low HAP emissions; lower cost than solvent-borne coatings and no additives, thinners, or hardeners are required in most cases; less coating is required to cover the same surface area as compared to the use of solvent borne coating solutions; and paint guns can be readily cleaned with water or water-based solutions and do not require paint thinner, acetone, or methyl acetate (further environmentally friendly and user safety friendly). Thus, byproducts from cleaning processing equipment used to produce waterborne coatings are also more environmentally and user friendly compared to byproducts from solvent borne coatings.

Within the context of the present invention, the term “substantially unreactive with” is intend to mean that if any reactions did occur after mixing two or more polymers together, then the number of reactions between the polymers are so few and insignificant that the overall viscosity of the mixture remains below 120 Krebs units after being stored for 30 days at 40 degrees Celsius. This viscosity limit indicates that no gelling has occurred, and thus, the resin component is still usable for coating applications with consistent performance properties.

The present invention relates to the formulation of hybrid polyurethane-epoxy waterborne primer coatings, methods used to prepare the primer coatings, and their use as coatings on substrates. The hybrid waterborne primers of the invention can be used alone as a direct-to-substrate (or in certain embodiments, direct-to-metal or “DTM”) primer or in combination with an etch primer or a surface treatment on the substrate to be coated such as some other chemical surface treatment to render the surface of the substrate better able to receive and bond with the hybrid waterborne primer of the invention.

Coatings formed of epoxy resin dispersions typically demonstrate good chemical and thermal stability, adhesive and mechanical strength, which can be used for anti-corrosion properties. However, epoxy resin dispersions often exhibit a high rigidity property, which can reduce the flexibility of a coating formed therefrom, and sanding capability is also a challenge. For example, epoxy resin dispersion prepared from bisphenol-A (BPA) has poor anti-UV properties due to many benzene rings in polymer chain. Coatings formed of polyurethane resins are typically less prone to scratching and cracking but sometimes have poor thermal stability and chemical resistance.

The disclosed hybrid epoxy-polyurethane waterborne primer coatings comprises a network of crosslinked epoxy resin regions and crosslinked polyurethane resin regions to provide a balance of properties with better performance compared with conventional solvent borne primers comprising only epoxy or only polyurethane. Additionally, the crosslinked epoxy resin regions are formed, in part, using isocyanates, which reduces drying time and improves sanding capabilities of the hybrid epoxy-polyurethane waterborne primer. The disclosed hybrid epoxy-polyurethane waterborne primer may be used for any desired end use, including, but not limited to, the architectural, automotive, construction, marine, aerospace, and similar industries.

The hybrid polyurethane-epoxy waterborne primer may be formed from a waterborne epoxy resin dispersion, a polyurethane dispersion, an isocyanate, and a non-isocyanate crosslinker component. Upon mixing these components, a hybrid polymer network is formed and comprises crosslinked epoxy resin regions and crosslinked polyurethane resin regions. Optionally, the crosslinked epoxy resin regions and the crosslinked polyurethane regions are crosslinked with one another. The hybrid polyurethane-epoxy waterborne primer may be waterborne and provides a balance of favorable properties attributable to the crosslinked epoxy resin regions and the crosslinked polyurethane resin regions (e.g., chemical resistance, mechanical properties, adhesion properties, weatherability, cure rates, potlife, anti-corrosion, dry-time, less porosity, etc.).

In some embodiments, the hybrid polyurethane-epoxy waterborne primer may be available as a three-component (“3K”) system. The 3K system comprises a first part, a second part, and a third part. The first part comprises a waterborne epoxy resin dispersion; the second part comprises a polyurethane dispersion; and the third part comprises a non-isocyanate crosslinker component, and optionally further comprises an isocyanate. Each part is shelf-stable. For example, in the third part, the isocyanate (when present) and the non-isocyanate crosslinker component are substantially unreactive with one another. The polyurethane dispersion may comprise carboxyl groups, which are reactive with the non-isocyanate crosslinker component. In some embodiments, the polyurethane dispersion may further comprise quaternary ammonium salt functional groups, which may accelerate the crosslinking reaction of the epoxy resin dispersion. The non-isocyanate crosslinker component may comprise a carbodiimide compound, a polycarbodiimide compound, an aziridine compound, a polyaziridine compound, or a combination thereof. By using carbodiimide or aziridine compounds, the hybrid polyurethane-epoxy waterborne primer may be formulated to cure at room temperature and does not require a particular pH. Further, the non-isocyanate crosslinker component is compatible with common waterborne polyacrylic disperser additives. The epoxy resin dispersion may comprise hydroxyl functional groups, which are reactive with the isocyanate.

Upon mixing the first part, the second part, and the third part, the non-isocyanate crosslinker component reacts with the polyurethane dispersion to formed crosslinked polyurethane resin, and the isocyanate (when present) reacts with the epoxy resin dispersion to form crosslinked epoxy resin. In particular, curing (or crosslinking) of the epoxy resin dispersion in certain embodiments is at least based on a reaction between the hydroxyl groups of the epoxy resin dispersion and the isocyanate (when present); and curing (or crosslinking) of the polyurethane dispersion in certain embodiments is at least based on a reaction between carboxyl groups on the polyurethane dispersion and the non-isocyanate crosslinker component. As the crosslinking of the epoxy resin dispersion and the crosslinking of the polyurethane dispersion progresses, the crosslinked epoxy resin becomes interlaced with the crosslinked polyurethane resin.

Further, curing (or crosslinking) between the crosslinked epoxy resin regions and the crosslinked polyurethane regions may be present. For example, the carboxyl group of the polyurethane dispersion may be reactive with the epoxide groups. When the polyurethane further comprises quaternary ammonium salt functional groups, the quaternary ammonium salt functional groups may facilitate reactions with the epoxide groups. Further, under the right conditions, it is also possible, though not always expected, for the non-isocyanate crosslinker component to react with the epoxy resin dispersion and/or for the isocyanate (when present) to react with the polyurethane dispersion to form additional crosslinking between the crosslinked epoxy resin regions and the crosslinked polyurethane resin regions. If any carboxyl groups from the polyurethane dispersion react with the isocyanates, the reaction rate is significantly slower at room temperature and within the waterborne solutions compared to the reaction rate of the carboxyl groups with the non-isocyanate crosslinker component. Thus, it is expected that crosslinking within the polyurethane dispersion is predominantly from reactions between the carboxyl groups and the non-isocyanate crosslinker component.

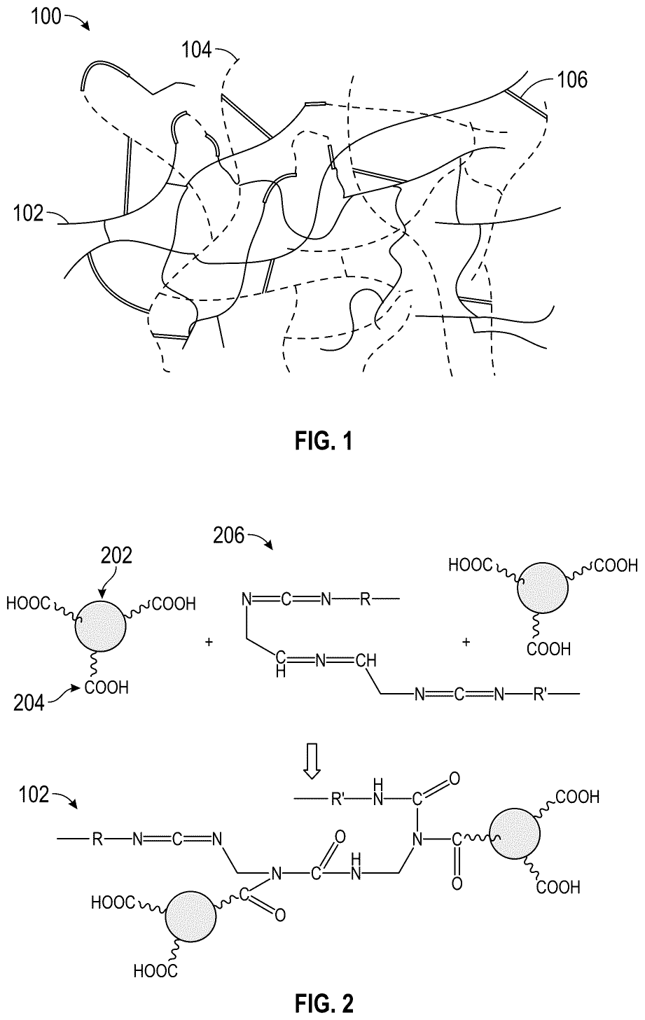

FIGS. 1-6 further help explain the reactions that can be used in preparing various embodiments of the hybrid polyurethane-epoxy waterborne primer.

FIG. 1 presents a schematic of some embodiments of the hybrid polyurethane-epoxy waterborne primer a hybrid polymer network 100. The hybrid polymer network 100 comprises regions of the crosslinked polyurethane resin 102 and regions of the crosslinked epoxy resin regions 104. In some embodiments, the crosslinked polyurethane resin regions 102 are further chemically connected with the crosslinked epoxy resin regions 104 via crosslinking 106. It will be appreciated while the crosslinking 106 illustrated in FIG. 1 appears to be distinct from the other crosslinked regions 102, 104, the crosslinking 106 actually comprises a combination of the polyurethane resin regions 102 and the epoxy resin regions 104. Additionally, the relative ratio of polyurethane resin regions 102, epoxy resin regions 104, and crosslinking 106 in FIG. 1 is simply exemplary and can vary depending on the ratio of reactants used to form the hybrid polyurethane-epoxy waterborne primer.

In such a crosslinked polymer network 100, the crosslinked polyurethane resin 102 and the crosslinked epoxy resin regions 104 are mechanically connected through entanglement and chemically connected through crosslinking 106. In some other embodiments, the crosslinking 106 is omitted such that the hybrid polymer network 100 is a true interpenetrating polymer network, where the crosslinked polyurethane resin 102 and the crosslinked epoxy resin 104 are entangled and penetrate with one another but are substantially not or more preferably not crosslinked with one another. In other words, in such a true interpenetrating polymer network, the crosslinked polyurethane resin 102 is mechanically connected through entanglement but not chemically connected with the crosslinked epoxy resin regions 104.

FIG. 2 presents a schematic of some embodiments of a crosslinking reaction to form the crosslinked polyurethane resin 102. As seen in FIG. 2, in some embodiments, a polyurethane dispersion 202 comprises carboxyl groups 204. A polycarbodiimide 206 may react with the carboxyl groups 204 of two compounds of the polyurethane dispersion 202 to from the crosslinked polyurethane resin 102. While not illustrated in FIG. 2, several reaction steps occur to form the crosslinked polyurethane resin 102. While not being bound by any particular mechanism, it is believed that at first, an O-acyl urea is formed from a reaction between the polycarbodiimide with one carboxyl group 204. The O-acyl urea quickly turns into an N-acyl urea via an internal rearrangement or by reaction with a second carboxyl group 204. Upon reaction with a second carboxyl group 204, the O-acyl urea forms an anhydride and a urea group to form the crosslinked polyurethane resin 102. Alternatively, the O-acyl urea may internally rearrange into an N-acyl urea when the carbonyl group shifts from an oxygen atom to an adjacent nitrogen atom. The N-acyl urea is relatively stable but is reactive with available carboxyl groups 204 to from the crosslinked polyurethane resin 102. While the N-acyl urea can dissociate into an isocyanate and amide at high temperatures or upon reaction with carboxyl groups 204, the restricted mobility created by the various crosslinking reactions promotes the isocyanate and amide to recombine into the N-acyl urea. The recombined N-acyl urea will react with available carboxyl groups 204 to form the crosslinked polyurethane resin 102. In short, over time, the non-isocyanate crosslinker component 206 fully reacts with the free carboxyl groups 204 of the polyurethane dispersion 202 to form carbonyl urea groups, which ultimately forms a fully cured, crosslinked polyurethane resin 102.

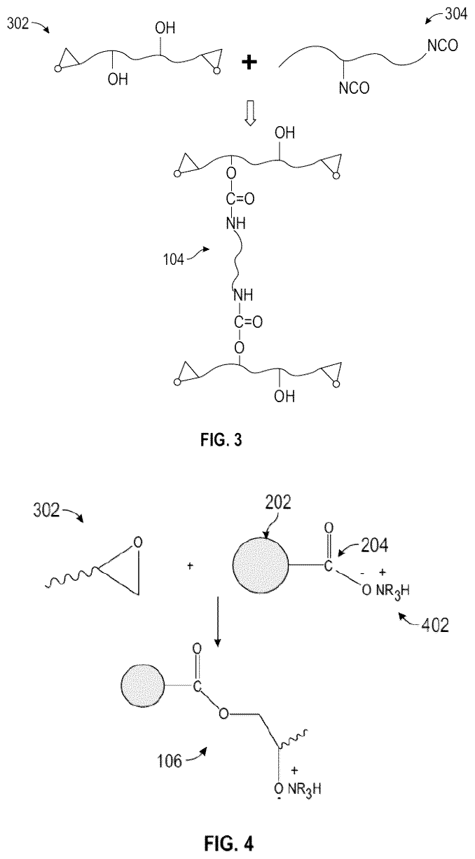

FIG. 3 presents a schematic of some embodiments of the reaction between an epoxy resin dispersion 302 and an isocyanate 304 to form crosslinked epoxy resin regions 104. As seen in FIG. 3, in some embodiments, the isocyanate 304 is a polyisocyanate with a branched aliphatic structure. Further, the isocyanate 304 may be a di-, tri-, or higher functional polyisocyanate. In some other embodiments, the isocyanate 304 may be aromatic, linear, or some other suitable structure and combinations thereof to promote crosslinking between the epoxy resin dispersion 302. The isocyanate functional groups on the polyisocyanate additive 304 react with the hydroxyl groups on the epoxy resin dispersion 302 to form urethane linkages to form the crosslinked epoxy resin regions 104. By using an isocyanate 304 to perform crosslinking within an epoxy resin dispersion 302, the hybrid polyurethane-epoxy waterborne primer can dry faster and therefore, be sanded soon after coating the hybrid polyurethane-epoxy waterborne primer on a substrate. Even with the fast drying properties provided by the isocyanate, the hybrid polyurethane-epoxy waterborne primer may still have a favorable potlife that is greater than 1 hour.

FIG. 4 presents a schematic of some embodiments of a crosslinking reaction between a polyurethane dispersion 202 and an epoxy resin dispersion 302 when the polyurethane dispersion 104 further comprises quaternary ammonium salts of pendant carboxyl functional groups 402. The carboxylate anion of this quaternary ammonium salt 402 is reactive with the epoxy resin dispersion 302. As the carboxylate anion opens the rings of the epoxy resin dispersion 302, crosslinking 106 between the polyurethane dispersion 202 and the epoxy resin dispersion 302 is formed. Thus, the epoxy resin dispersion 302 may be crosslinked to other polymers via opening-ring reactions facilitated by the quaternary ammonium salt 402 in the polyurethane dispersion and also by the reaction between the isocyanate and the hydroxyl groups on the epoxy resin dispersion 302 that form urethane linkages.

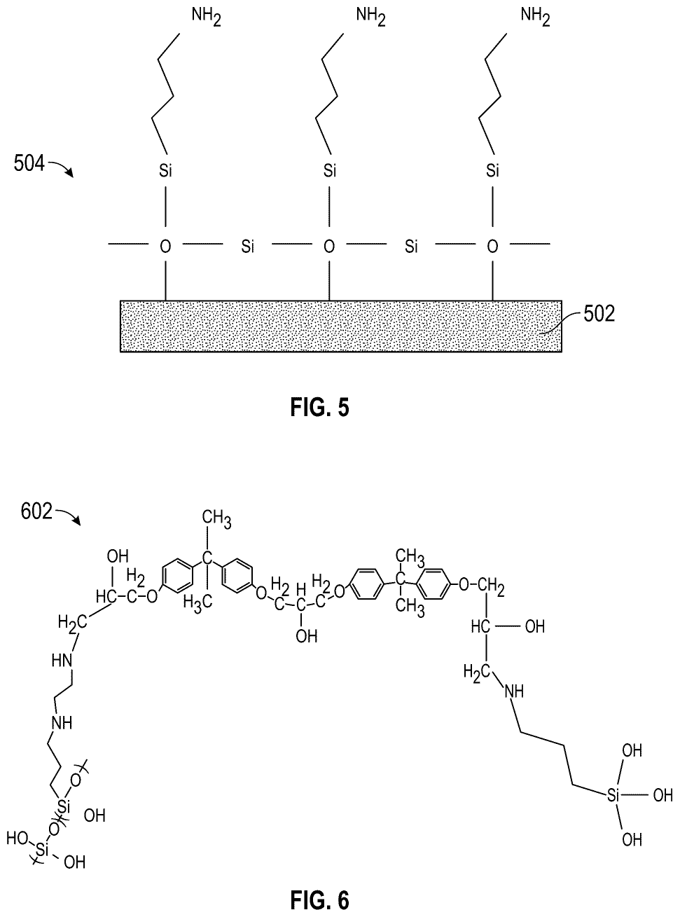

FIG. 5 presents a magnified view of some embodiments of an etch primer 504 comprising polysiloxane resin regions over a substrate 502 that is ready to receive the hybrid polyurethane-epoxy waterborne primer. In some embodiments, the substrate 502 comprises a metal, such as a cold roll steel, aluminum, or some other suitable metal. In some other embodiments, the substrate 502 comprises a plastic, a composite comprising plastic and metal, a glass, a ceramic, or some other material. In some embodiments, the etch primer 504 comprises hybrid epoxy-polysiloxane etch primer composition. As will be described further herein, the hybrid epoxy-polysiloxane etch primer composition may comprise silicon based compounds having hydroxyl and/or amino functional groups. At least when the substrate 502 comprises cold rolled steel and the etch primer 504 comprises a hybrid epoxy-polysiloxane composition, the etch primer 504 may hydrolyze first and then condense with hydroxyl groups on the substrate 502 to form covalent bonds with the surface of the substrate 502. These covalent bonds are significantly stronger than physical bonding such as van der Waal's forces or hydrogen bonding. The silicon based compounds may also bond to each other via condensation reactions. A grafted polymer structure formed from the second silicon based compounds may form over the substrate 502.

As shown in FIG. 5, additional functional groups (e.g., the NH₂ groups) may then be available for further reactions with available epoxy groups within the hybrid epoxy-polysiloxane etch primer and with available epoxide groups from the hybrid polyurethane-epoxy waterborne primer when applied to the etch primer 504. For example, the available amine groups from the hybrid epoxy-polysiloxane etch primer may react with the epoxide groups from the hybrid polyurethane-epoxy waterborne primer through opening-ring reactions. Thus, the silicon based compounds from the etch primer 504 bonded to the substrate 502 assist in providing strong adhesion between the hybrid epoxy-polysiloxane etch primer 504 and the substrate 502. It will be appreciated that in some other embodiments, the hybrid polyurethane-epoxy waterborne primer may be applied directly to the substrate 502 without an additional separate etch primer layer 504. In some other embodiments, the etch primer 504 may comprise some other composition with free functional groups ready to react with components of the hybrid polyurethane-epoxy waterborne primer to assist with adhesion between the substrate 502 and the hybrid polyurethane-epoxy waterborne primer.

FIG. 6 presents a schematic of some embodiments of a portion 602 of the hybrid epoxy-polysiloxane etch primer. In some embodiments, the hybrid epoxy-polysiloxane etch primer comprises crosslinked epoxy resin regions and crosslinked polysiloxane regions. The crosslinked epoxy resin regions may be formed from an epoxy resin dispersion, an aliphatic amine, and one or more first silicon based compounds containing one or more amino or hydroxyl functional groups. The crosslinked polysiloxane resin regions may be formed from one or more second silicon based compounds containing one or more amino or hydroxyl functional groups. As discussed above in FIG. 5, hydroxyl groups of the first and/or second silicon based compounds may hydrolyze onto the substrate and further react with other available functional groups.

Additionally, upon mixing the components of the hybrid epoxy-polysiloxane etch primer, the epoxy resin dispersion may be reactive with amine groups from the first and/or second silicon based compound, thereby forming crosslinks between the crosslinked epoxy resin regions and the crosslinked polysiloxane regions, as illustrated by the portion 602 in FIG. 6. When the hybrid polyurethane-epoxy waterborne primer is applied to the hybrid epoxy-polysiloxane etch primer, any unreacted amine groups from the first and/or second silicon based compounds may also react with the epoxide groups of the hybrid polyurethane-epoxy waterborne primer to promote adhesion between the hybrid polyurethane-epoxy waterborne primer and the hybrid epoxy-polysiloxane etch primer. The availability of crosslinking within the etch primer, within the primer, and between the etch primer and the primer increases the crosslinking density of the overall coatings system, which improves the adhesion and anti-corrosion properties of the coatings system.

As illustrated in FIGS. 2-4, upon mixing the epoxy resin dispersion, the polyurethane dispersion, the non-isocyanate crosslinker component, and the isocyanate with one another, a combination of reactions occur to form the hybrid polyurethane-epoxy waterborne primer. As will be discussed herein, the structures and amounts of the epoxy resin dispersion, the polyurethane dispersion, the non-isocyanate crosslinker component, and the isocyanate influence the resulting structure and properties of the hybrid polyurethane-epoxy waterborne primer.

For example, one or more types of epoxy resin dispersions may be used to achieve desired properties of the hybrid polyurethane-epoxy waterborne primer. The epoxy resin dispersion includes, but is not limited to, epoxies formed from epichlorohydrin and one or more bisphenol compounds. The one or more bisphenol compounds can be any suitable bisphenol compound and can be selected based on the end properties desired from the crosslinked epoxy resin regions of the hybrid polyurethane-epoxy waterborne primer. In certain embodiments, the bisphenol compound includes but is not limited to one or more compounds selected from the following:

| Structural formula | Name | CAS |
|---|---|---|
| 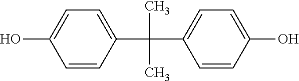 [SMILES: CC(C)(c1ccc(O)cc1)c1ccc(O)cc1] | Bisphenol A | 80-05-7 |
| 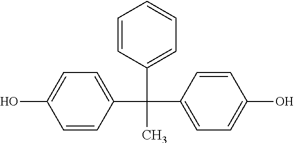 [SMILES: CC(c1ccccc1)(c1ccc(O)cc1)c1ccc(O)cc1] | Bisphenol AP | 1571-75-1 |
| 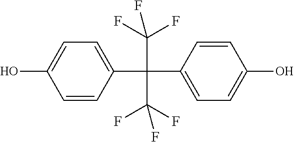 [SMILES: Oc1ccc(C(c2ccc(O)cc2)(C(F)(F)F)C(F)(F)F)cc1] | Bisphenol AF | 1478-61-1 |
| 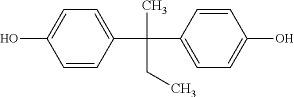 [SMILES: CCC(C)(c1ccc(O)cc1)c1ccc(O)cc1] | Bisphenol B | 77-40-7 |
| 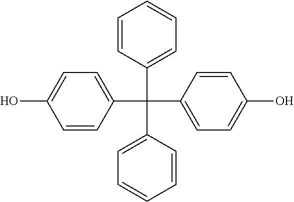 [SMILES: Oc1ccc(C(c2ccccc2)(c2ccccc2)c2ccc(O)cc2)cc1] | Bisphenol BP | 1844-01-5 |
| 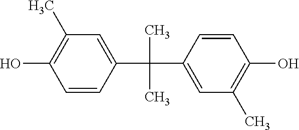 [SMILES: Cc1cc(C(C)(C)c2ccc(O)c(C)c2)ccc1O] | Bisphenol C | 79-97-0 |
| 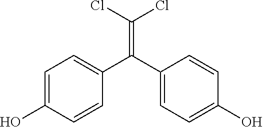 [SMILES: Oc1ccc(C(=C(Cl)Cl)c2ccc(O)cc2)cc1] | Bisphenol C 2 | 14868-03-2 |
| 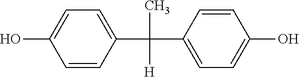 [SMILES: CC(c1ccc(O)cc1)c1ccc(O)cc1] | Bisphenol E | 2081-08-5 |
| 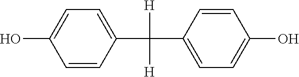 [SMILES: Oc1ccc(Cc2ccc(O)cc2)cc1] | Bisphenol F | 620-92-8 |
| 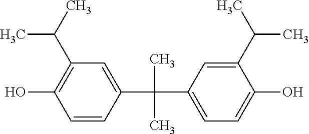 [SMILES: CC(C)c1cc(C(C)(C)c2ccc(O)c(C(C)C)c2)ccc1O] | Bisphenol G | 127-54-8 |
| 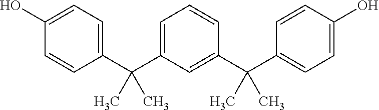 [SMILES: CC(C)(c1ccc(O)cc1)c1cccc(C(C)(C)c2ccc(O)cc2)c1] | Bisphenol M | 13595-25-0 |
| 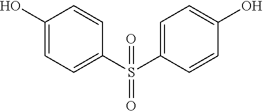 [SMILES: O=S(=O)(c1ccc(O)cc1)c1ccc(O)cc1] | Bisphenol S | 80-09-1 |
| 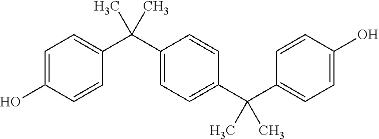 [SMILES: CC(C)(c1ccc(O)cc1)c1ccc(C(C)(C)c2ccc(O)cc2)cc1] | Bisphenol P | 2167-51-3 |
| 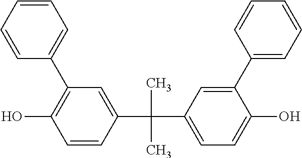 [SMILES: CC(C)(c1ccc(O)c(-c2ccccc2)c1)c1ccc(O)c(-c2ccccc2)c1] | Bisphenol PH | 24038-68-4 |
| 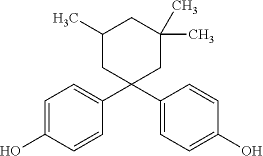 [SMILES: CC1CC(C)(C)CC(c2ccc(O)cc2)(c2ccc(O)cc2)C1] | Bisphenol TMC | 129188-99-4 |
| 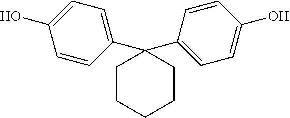 [SMILES: Oc1ccc(C2(c3ccc(O)cc3)CCCCC2)cc1] | Bisphenol Z | 843-55-0 |
| 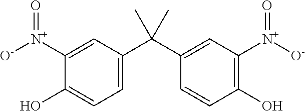 [SMILES: CC(C)(c1ccc(O)c([N+](=O)[O-])c1)c1ccc(O)c([N+](=O)[O-])c1] | Dinitrobisphenol A | 5329-21-5 |
| 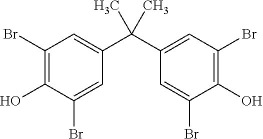 [SMILES: CC(C)(c1cc(Br)c(O)c(Br)c1)c1cc(Br)c(O)c(Br)c1] | Tetrabromobisphenol A | 79-94-7 |

Preferably, the one or more bisphenol compounds are selected from the group consisting of bisphenol A, bisphenol B, bisphenol E, bisphenol F, and bisphenol AF.

Curing (or crosslinking) of the epoxy resin dispersion is at least based on the formation of urethane linkages when the epoxy resin dispersion with hydroxyl groups is mixed with isocyanates as discussed above with respect to FIG. 3. Additionally, under certain conditions, the epoxy resin dispersion may also cure with itself (homopolymerisation) or by forming a copolymer with polyfunctional curatives or hardeners. This curing is what produces the qualities of the hybrid polyurethane-epoxy waterborne primer such as its resistance, durability, versatility, adhesion, and fast dry-time yet long potlife. Common classes of hardeners for epoxy resin dispersions include amines, acids, acid anhydrides, phenols, alcohols and thiols. These have a relative reactivity (lowest first) approximately in the order: phenol<anhydride<aromatic amine<cycloaliphatic amine<aliphatic amine<thiol. While some epoxy resin dispersion/hardener combinations will cure at ambient temperature, some may require heat. Temperature is sometimes increased in a step-wise fashion to control the rate of curing and prevent excessive heat build-up from the exothermic reaction.

Hardeners which show only low or limited reactivity at ambient temperature, but which react with epoxy resin dispersions at elevated temperature are referred to as latent hardeners. When using latent hardeners, the epoxy resin dispersion and hardener may be mixed and stored for some time prior to use, which is advantageous for many industrial processes. For example, when the hybrid polyurethane-epoxy waterborne primer is sold to customers as a 3K system, the epoxy resin dispersion and hardeners may be sold as a first part, the polyurethane dispersion may be sold as the second part, and the isocyanate and non-isocyanate crosslinker component may be sold as the third part. Upon mixing the first, second, and third parts and heating the mixture, the epoxy resin dispersion may crosslink to form crosslinked epoxy resin regions via reaction with the latent hardeners, any hydroxyl and/or amino functional groups from other present compounds (e.g., quaternary ammonium salt or underlying etch primer layer), the isocyanate, and even possibly via homopolymerisation.

The epoxy curing reaction may also be accelerated by addition of small quantities of accelerators. Tertiary amines from quaternary ammonium salts, carboxylic acids, and alcohols (especially phenols) are effective accelerators. These additional accelerators are typically present in the second or third parts such that the first part comprising the epoxy resin dispersion remains shelf-stable. For example, as discussed above, the polyurethane dispersion in the second part may comprise carboxyl groups and quaternary ammonium salts. In some other embodiments, the accelerators, such as a latent accelerator, for the epoxy resin dispersion may be in the first part as long as the first part can still be shelf-stable at ambient conditions.

The hybrid polyurethane-epoxy waterborne primer of the present invention may also include other optional ingredients that do not adversely affect the hybrid primer composition or a cured coating resulting therefrom. Such optional ingredients include, for example, catalysts, dyes, pigments, toners, extenders, fillers, lubricants, anticorrosion agents, flow control agents, thixotropic agents, dispersing agents, antioxidants, adhesion promoters, light stabilizers, surfactants, and mixtures thereof. Each optional ingredient is preferably included in a sufficient amount to serve its intended purpose, but not in such an amount to adversely affect the hybrid polyurethane-epoxy waterborne primer or a cured coating resulting therefrom. When the disclosed hybrid polyurethane-epoxy waterborne primer is formulated as a 3K system, optional ingredients are included in one or more of the parts given the addition of the optional ingredients do not substantially react (and threaten shelf-stability) with other contents within the part.

The hybrid polyurethane-epoxy waterborne primer can be prepared by any desired method by which the epoxy resin dispersion, the polyurethane dispersion, the isocyanate, and non-isocyanate crosslinker component react and become a crosslinked network having crosslinked epoxy resin regions and crosslinked polyurethane resin regions.

As a non-limiting example, in some embodiments, the epoxy resin dispersion comprises a latex epoxy dissolved in de-ionized water as a primary solvent and an organic solvent as a co-solvent. Because water is the primary solvent, meaning because there is more water than organic solvent, the overall epoxy resin dispersion is still considered waterborne. In one exemplary embodiment, the co-solvent may be dipropylene glycol dimethyl ether. In some embodiments, the epoxy resin dispersion further comprises various dispersants, deformers, pigments, anti-rust agents, anti-corrosion agents, fillers, leveling agents, epoxy latex, rheology modifiers, binders, and the like.

As a non-limiting example, in some embodiments, the polyurethane dispersion comprises a polyurethane disperser with carboxyl and quaternary ammonium salt functional groups dissolved in in de-ionized water as a primary solvent and an organic solvent as a co-solvent. Because water is the primary solvent, meaning because there is more water than organic solvent, the overall polyurethane dispersion is still considered waterborne. In one exemplary embodiment, the co-solvent of the polyurethane dispersion may be dipropylene glycol dimethyl ether. In some embodiments, the polyurethane dispersion further comprises various dispersants, deformers, pigments, anti-rust agents, anti-corrosion agents, fillers, leveling agents, rheology modifiers, binders, and the like.

In some embodiments, the epoxy resin dispersion is stored separately from the polyurethane dispersion. When it is time to use the hybrid polyurethane-epoxy waterborne primer, then the epoxy resin dispersion and the polyurethane dispersion may be mixed together with the non-isocyanate crosslinker component and the isocyanate in a predetermined ratio. The non-isocyanate crosslinker component may be premixed with the isocyanate, or the non-isocyanate crosslinker component may be stored separately from the isocyanate. In some embodiments, the non-isocyanate crosslinker component and the isocyanate may together or separately be dissolved in a waterborne solution. The mixture of the epoxy resin dispersion, the polyurethane dispersion, the isocyanate, and the non-isocyanate crosslinker component is waterborne.

Other non-limiting examples of suitable organic solvents for use in the primarily waterborne coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

When stored, each part of the hybrid polyurethane-epoxy waterborne primer is individually substantially unreactive, meaning the epoxy resin dispersion, the polyurethane dispersion, the isocyanate, and the non-isocyanate crosslinker component are individually shelf-stable. For example, the first part, comprising the epoxy resin dispersion, remained shelf-stable or substantially unreactive when maintained at 40 degrees Celsius for 30 days. For example, some formulations of the waterborne epoxy resin dispersion used in the hybrid polyurethane-epoxy waterborne primer system showed a minor variation (about 10 Krebs units) in viscosity over the 30 days. Similarly, some formulations of the waterborne epoxy resin dispersion used in the hybrid polyurethane-epoxy waterborne primer system showed a minor variation (about 1 pH unit) in pH over the 30 days. In some embodiments, the viscosity of the first part is in a range of between about 50 Krebs units and about 80 Krebs units, and the pH of the first part is in a range of between about 7 and about 9, for example. When shelf-stability is desired, the epoxy resin dispersion may be formulated such that homopolymerisation of the epoxy resin dispersion is unlikely at the anticipated temperature conditions for storage such that the epoxide rings remain closed and available for a ring-opening reaction and that the hydroxyl groups remain available for reactions with isocyanates when the epoxy resin dispersion is later mixed with the second and third parts.

The second part, comprising the polyurethane dispersion with carboxyl functional groups and quaternary ammonium salt functional groups was also substantially unreactive when stored at 40 degrees Celsius for 30 days. For example, some formulations of the waterborne polyurethane dispersion used in the hybrid polyurethane-epoxy waterborne primer system showed a minor variation (about 15 Krebs units) in viscosity over the 30 days. Similarly, some formulations of the waterborne polyurethane dispersion used in the hybrid polyurethane-epoxy waterborne primer system showed a minor variation (less than 1 pH unit) in pH over the 30 days. In some embodiments, the viscosity of the second part is in a range of between about 40 Krebs units and about 60 Krebs units, and the pH of the second part is in a range of between about 8 and about 9, for example.

It will be appreciated that the epoxy resin dispersion in the first part may comprise other functional groups within its polymer chains given these other functional groups are substantially unreactive with the epoxy resin dispersion, the hydroxyl groups, and other components of the first part such that the first part remains shelf-stable. Similarly, it will be appreciated that the polyurethane dispersion in the second part may contain other functional groups within its polymer chains given these other functional groups are substantially unreactive with the carboxyl and quaternary ammonium salt functional groups (if present) such that the second part remains shelf-stable. Further, it will be appreciated that the isocyanate may contain other functional groups within its polymer chains given these other functional groups are substantially unreactive with the isocyanate and the non-isocyanate crosslinker component (if also in stored in the third part with the isocyanate). The non-isocyanate crosslinker component may contain other functional groups within its polymer chains given these other functional groups are substantially unreactive with the non-isocyanate crosslinker component and the isocyanate (if also in stored in the third part with the non-isocyanate crosslinker component). Any additional functional groups in the first, second, and third parts should also be selected such that when the first, second, and third parts are combined, the crosslinking reactions to form the hybrid polyurethane-epoxy waterborne primer can still occur such that the cured hybrid polyurethane-epoxy waterborne primer has its desired favorable properties.

When a substrate is ready for coating, the first, second, and third parts are mixed together at a predetermined ratio to begin forming a network comprising crosslinked epoxy resin regions and crosslinked polyurethane resin regions.

For example, in some embodiments, a ratio between the equivalent weight of carboxyl groups in the second part to the isocyanate groups in the third part may be in a range of between preferably about 0.5 and about 8, more preferably about 2 and about 7, or even more preferably about 4 to about 6. In some embodiments, a ratio between the equivalent weight of carboxyl groups in the second part to the diimide groups in the non-isocyanate crosslinker component of the third part may be in a range of between preferably about 0.5 and about 8, more preferably about 3 and about 7, or even more preferably about 3 to about 4.

In some embodiments, the weight percent of epoxy resin dispersion of the first part in the mixture is preferably about 10 percent to about 50 percent, more preferably about 15 percent to about 40 percent, and even more preferably about 20 percent to about 30 percent. In some embodiments, the weight percent of polyurethane dispersion of the second part in the mixture is preferably about 50 percent to about 90 percent, more preferably about 60 percent to about 85 percent, and even more preferably about 70 percent to about 80 percent. In some embodiments, the weight percent of the polyisocyanate of the third part in the mixture is preferably about 0.5 percent to about 10 percent, more preferably about 1 percent to about 8 percent, and even more preferably about 2 percent to about 6 percent. In some embodiments, the weight percent of the polycarbodiimide of the non-isocyanate crosslinker component from the third in the mixture is preferably about 0.1 percent to about 10 percent, more preferably about 0.2 percent to about 5percent, and even more preferably about 0.3 percent to about 1 percent. It will be appreciated that the ratio of functional groups and weight percents within the 3K system may be tuned for desirable properties such as potlife, mechanical strength, adhesion, corrosion resistance, and the like.

The parts may be mixed together using a paint stick, a bucket agitator, an electric mixing attachment, or some other suitable tool at room temperature. The speed of reaction for crosslinking the epoxy resin dispersion upon mixing may be measured, for example, by FTIR by monitoring a change in the epoxy resin dispersion reactant. Such a “change” may be a change in structure or amount of a reactant, functional group, byproduct, or a change in some other indicator that the reaction has progressed. For example, in some embodiments, the disappearance of the epoxy ring, which indicates the progression of some crosslinking of the epoxy resin dispersion, corresponds to change in peaks on the FTIR associated with asymmetric C—O—C stretching vibrations. The disappearance of hydroxyl groups measured by, for example, FTIR may also indicate the progression of some crosslinking of the epoxy resin dispersion. As discussed in FIG. 2, crosslinking between the polyurethane dispersion occurs as the non-crosslinker component, such as a carbodiimide, reacts with carboxyl groups of the polyurethane dispersion. Therefore, in some embodiments, a reduction in the amount of carboxyl groups and/or a reduction in the amount of carbodiimide groups may be detected from FTIR data to indicate the speed of crosslinking reactions within the polyurethane dispersion.

While the hybrid polyurethane-epoxy waterborne primer can be sold as a 3K system, it will be appreciated that in some industrial settings, more than three components may be used; for example, the epoxy resin dispersion, the polyurethane dispersion, the isocyanate, the non-isocyanate crosslinker component, and/or any other additives may be sequentially or simultaneously added to a same mixture. If the components are added sequentially, the time between adding each component should be minimized to allow the various crosslinking reactions within the mixture to occur simultaneously to form the hybrid crosslinked network.

In some embodiments, the potlife of the mixture of the first and second parts with isocyanate and polycarbodiimide may be in a range of between about 1 hour and about 5 hours at room temperature, which is significantly longer than common polyurethane coatings cured by isocyanates. The resulting mixture of the hybrid polyurethane-epoxy waterborne primer composition may be applied to a prepared substrate as a coating via rolling, brushing, spraying, or some other suitable coating method. The coating may be applied at a thickness of between, for example, approximately 1 mils and approximately 7 mils. It was observed that the chemical and mechanical properties of the waterborne coatings system did not vary significantly based on dry film thickness of the hybrid polyurethane-epoxy waterborne primer layer varied from about 4.5 mil to about 6.0 mil.

Over time, the non-isocyanate crosslinker component promotes crosslinking through a reaction with the carboxyl groups in the polyurethane dispersion, and the isocyanate promotes crosslinking amongst the epoxy resin dispersion. The hybrid polymer network, comprising crosslinked epoxy resin regions intertangled with crosslinked polyurethane resin regions, begins to form as these crosslinking reactions progress. Additionally, crosslinking reactions may occur between the crosslinked epoxy resin regions and the crosslinked polyurethane resin regions. The hybrid polymer network forms a hybrid polyurethane-epoxy waterborne primer coating over the substrate, and eventually, once all of the reactions are complete, this hybrid polyurethane-epoxy waterborne primer coating cures over the substrate. One or more layers of the hybrid polyurethane-epoxy waterborne primer coating may be applied over the substrate depending on the desired mechanical properties of the coatings system. Between each layer, the hybrid polyurethane-epoxy waterborne primer coating may optionally be sanded. Because the isocyanate is used to crosslink portions of the epoxy resin dispersion, the time between applying a coat and sanding the coat of hybrid polyurethane-epoxy waterborne primer is reduced compared to crosslinking the epoxy resin dispersion primarily through amines.

As discussed above with respect to FIGS. 5 and 6, for example, in some embodiments, the substrate is prepared to receive the hybrid polyurethane-epoxy waterborne primer coating by first applying a waterborne etch primer coating to the substrate. A waterborne etch primer may be used because the hybrid polyurethane-epoxy waterborne primer coating is also waterborne. In some embodiments, the etch primer coating comprises an epoxy-polysiloxane network.

In some embodiments, the hybrid polyurethane-epoxy waterborne primer coating acts as a primer layer configured to receive an overlying coating. In some such embodiments, one or more overlying coatings such as a base coat, a clearcoat, and the like may be applied to the hybrid polyurethane-epoxy waterborne primer coating upon the full or partial curing of the hybrid epoxy-polyurethane coating. As a primer layer, the hybrid polyurethane-epoxy waterborne primer coating may be formulated to adhere to both the underlying substrate or coating (e.g., a waterborne etch primer coating) and the overlying coatings. Thus, the coatings system may comprise the hybrid epoxy-polysiloxane etch primer layer; a hybrid polyurethane-epoxy waterborne primer layer over the hybrid epoxy-polysiloxane etch primer layer; a base coat over the hybrid polyurethane-epoxy waterborne primer layer; and a clear coat over the base coat. It will be appreciated that the coatings system may comprise one or more of each of the aforementioned coating layers. This coatings system may adhere to and protect the substrate. In some embodiments, one or more of the layers in the coatings system may be sanded prior to applying a subsequent layer of the coating system to promote a smooth finish.

The epoxy waterborne primer that can be used in certain embodiments of the present invention can be prepared as follows: Deionized water, a dispersant, a defoamer, a solvent, and an anti-rust agent are combined in a first container. Then, pigments, fillers and anti-corrosion agents are combined in a second container. Finally, the contents of the first and second containers are combined and mixed to form a uniform slurry. This slurry is then transferred to a third container, and mixed at high speed for a time period sufficient to thoroughly mix the contents. The resulting solution is cooled down, and an epoxy latex dispersion, a levelling agent, a defoamer, and a rheology modifier are combined with the mixed slurry in the third container, and the resulting composition mixed at slow speed at room temperature for a time period sufficient to thoroughly mix the contents.

The polyurethane waterborne primer formed form a polyurethane dispersion with carboxyl and quaternary ammonium salt as functional groups, used in certain embodiments of the present invention, can be prepared as follows: Deionized water, a dispersant, a defoamer, and a solvent are combined in a first container. Then, pigments, fillers and anti-corrosion agents respectively are added into a second container. Finally, the contents of the first and second container are combined and mixed until a uniform slurry is generated. The resulting mixed slurry is then placed in a third container, and mixed at high speed for a desired time period. The resulting solution is then cooled down, and a polyurethane dispersion having carboxyl and quaternary ammonium salt as functional groups, a levelling agent, a defoamer, and a rheology modifier are combined with the mixed composition in the third container, and the resulting composition mixed at slow speed for a time period to provide a well mixed slurry.

The hybrid epoxy-polysiloxane waterborne etch primer of certain embodiments can be prepared as follows: An epoxy waterborne primer of embodiments of the present invention is added to a first container, then an amine curing agent, a silane oligomer with hydroxyl and amine groups, and a silane with amine functional groups, are added to the first container. The resulting composition is stirred with until the amine and silanes totally dissolve into solution. The resulting hybrid epoxy-polysiloxane waterborne etch primer can then be sprayed on a substrate immediately. The pot life of such a hybrid epoxy-polysiloxane waterborne etch primer is preferably longer than one hour.

The hybrid epoxy-polyurethane waterborne primer prepared from a polyurethane dispersion containing carboxyl groups can be prepared as follows: To a first container, a polyurethane waterborne primer, an epoxy waterborne primer, an amine curing agent, such as an amine compound and a polycarbodiimide, and deionized water are added into the first container.

The resulting solution is stirred until all chemicals are dissolved. The resulting primer can be sprayed immediately, and the pot life of primer is preferably longer than one hour at room temperature.

The following examples of improved properties of the hybrid polyurethane-epoxy waterborne primer are provided to illustrate the present invention and its advantages but should not be construed as limiting a scope of the invention.

The following data was collected by comparing a conventional solvent borne coatings system with a waterborne coatings system. Each of the coatings systems comprises an etch primer layer over a substrate; a primer layer over the etch primer layer; a basecoat over the primer layer; and a clearcoat over the basecoat. The composition of the etch primer layer and/or the primer layer vary amongst each coatings system as presented in TABLE 1.

TABLE 1

| | CONVENTIONAL | WATERBORNE |
|---|---|---|
| Generic | SOLVENT BORNE | COATINGS |
| Layer Type | COATINGS SYSTEM | SYSTEM |
| CLEARCOAT | Conventional Clearcoat | Conventional Clearcoat |
| BASECOAT | Conventional Basecoat | Conventional Basecoat |
| PRIMER | Solvent borne | Hybrid Polyurethane-Epoxy |
| | Polyurethane | Waterborne Primer |
| ETCH PRIMER | Solvent borne Etch | Waterborne Hybrid Epoxy- |
| | Primer | Polysiloxane Etch Primer |
| SUBSTRATE | Cold Rolled Steel | Cold Rolled Steel |

Thus, as shown in TABLE 1, the conventional solvent borne coatings system comprises a conventional solvent borne etch primer layer over a cold roll steel substrate; a conventional solvent borne polyurethane over the conventional solvent borne etch primer layer; a conventional basecoat layer over the conventional solvent borne polyurethane primer layer; and a conventional clearcoat layer over the conventional basecoat layer. As shown in TABLE 1, the waterborne coatings system comprises a hybrid epoxy-polysiloxane etch primer layer over a cold roll steel substrate; a hybrid polyurethane-epoxy waterborne primer layer over the hybrid epoxy-polysiloxane etch primer layer; a conventional basecoat layer over the hybrid polyurethane-epoxy waterborne primer layer; and a conventional clearcoat layer over the conventional basecoat layer.

For each of the conventional solvent borne and waterborne coatings system, the cold roll steel substrates were prepared by sanding and cleaning the substrate with a solvent; drying the steel substrate at room temperature; spraying the appropriate etch primer layer to the prepared substrate; drying the appropriate etch primer layer at room temperature for one hour; applying the appropriate primer layer to the appropriate etch primer layer; drying the appropriate primer layer overnight at room temperature; sanding the appropriate primer layer; applying a basecoat layer to the appropriate primer layer; drying the basecoat layer for one hour; and applying a clearcoat layer to the basecoat layer. The samples were then rested at room temperature for 7 days before conducting the experimental tests discussed herein.

In some embodiments of the conventional solvent borne coatings system and the waterborne coatings system, the dry film thickness of the etch primer layer is in a range of about, for example, 0.5 mil and about 1.5 mil; the dry film thickness of the primer layer is in a range of about, for example, 4.5 mil and 6.0 mil; the dry film thickness of the basecoat layer is in a range of about 0.7 mil and about 1.0 mil; and the dry film thickness of the clearcoat layer is in a range of about 3 mil and about 5 mil. It will be appreciated that other dry film thickness values may be used as long as ample drying time is allowed between coating of layers.

In some embodiments, the dry time to a tack-free coating and the pot life was measured for each coatings system. Upon performing dry time and pot life tests, each primer layer of the coatings systems had a comparable tack-free dry time (e.g., less than 15 minutes with air forced dry and greater than 45 minutes with no air forced dry at room temperature) and pot life (e.g., greater than 60 minutes).

In some embodiments, the chemical resistance of just the etch primer layer and the primer layer arranged on the substrate of each coatings system can be tested by rubbing a paper soaked in methyl ethyl ketone (MEK) solvent on the substrate according to ASTM D5402-19. If the substrate is not exposed after 300 cycles of rubbing with MEK solvent, then the hybrid epoxy-polysiloxane etch primer coating is considered to be “chemically resistant.” The etch primer layer and the primer layer of conventional solvent borne coatings system and the waterborne coatings system can both withstand at least 300 cycles and thus, are both sufficiently “chemically resistant.” Thus, the chemical resistance of the etch primer and primer layers of both the conventional waterborne coatings system and waterborne coatings systems are comparable.

In some embodiments, the adhesive strength of each coatings system can be evaluated using crosshatch testing according to ASTM D3359. This test evaluates adhesive strength by applying and removing pressure-sensitive tape over cuts made in the coating. The substrate and coatings are monitored to see if the coatings peel away from the substrate and/or stick to the tape. Upon performing this adhesive strength test to just the etch primer and primer layer of each coatings system, each coatings system had comparable adhesive strength results. Upon performing this adhesive strength test to the entirety of each coatings system, the conventional solvent borne coatings system had adhesive loss between the primer layer and the basecoat, while the waterborne coatings system had adhesive loss between the etch primer layer and the substrate.

In some embodiments, the impact resistance of each coatings system can be evaluated according to ASTM D5420. This test evaluates direct and non-direct impact strength of the coatings. Upon performing this impact resistance test, the conventional solvent borne coatings system and the waterborne coatings system had substantially the same results. Stone chip testing was also performed to evaluate coating durability according to GM 14729, and the results were similar between the conventional solvent borne coatings system and the waterborne coatings system.

In some embodiments, the film flexibility of each coatings system can be evaluated according to a conical mandrel bend test disclosed in ASTM D522. Upon performing this flexibility test, each of the coatings systems received a passing score, meaning each coatings system exhibited a sufficient film flexibility for its intended applications.

In some embodiments, the optical appearance of each coatings system can be evaluated according to gloss retention at 20 degrees and/or distinctness of image (DOI) retention. Upon performing these optical appearance tests, each coatings system had similar gloss and DOI scores.

Each of the coatings systems had gloss values between 88 and 90. Each of the coatings systems had DOI scores between 90 and 95.

The optical appearance and adhesive loss of each sample was tested after being placed in a humidity chamber set at 30 degrees Celsius for 4 days. The optical appearance values were quantified by testing gloss retention at 20 degrees and DOI. Each sample was tested before entering the humidity chamber; within one hour after exiting the humidity chamber; and within 24 hours after exiting the humidity chamber. The optical appearance and adhesive loss of the waterborne coatings system were comparable or better than the optical appearance and adhesive loss of the conventional solvent borne systems. The improved results of the waterborne coatings system can be attributed to the increased crosslinking density of the etch primer and the primer layer in the waterborne coatings system compared to those layers in the conventional solvent borne system.

The flexibility of a film formed from a coating system of the present invention can be evaluated using a conical mandrel bend method according to ASTM D522.

To test the coating's behavior in a corrosive environment, each coatings system may be placed in a salt fog chamber at an elevated temperature for a few weeks (e.g., about 30 degrees Celsius for about 20 days). Prior to loading the substrates into the salt fog chamber, a scratch may be intentionally made into the primer layer and the etch primer layer of each coatings system. In some embodiments, the salt fog chamber testing is conducted in accordance with ASTM B117. After removing the substrates from the salt fog chamber, the amount of delamination and corrosion that occurred at the scratch is evaluated upon cleaning the substrates with hot water and removing any film loss. Some samples of the waterborne coatings system had less favorable delamination results compared to the conventional solvent borne coatings system. In a majority of the samples, each coatings system had the same amount of corrosion. Several samples of the waterborne coatings system were anti-corrosive at least due to the high degree of crosslinking within the etch primer layer, within the primer layer, and at the interface between the etch primer layer and the primer layer. With a high crosslinking density, the etch primer layer and the primer layer are more resistant to attack by base chemicals such as NaOH.

It can be appreciated that other test methods may be used to evaluate the above properties as well as other properties of each of the first and second coatings systems comprising the waterborne hybrid epoxy-polysiloxane etch primer and the conventional coatings system comprising conventional solvent borne coatings. Additionally, the above comparisons between the properties of each coatings system are exemplary and may change depending on the exact formulation and/or application method of each layer in each coatings system.

As evidenced by the above exemplary data, in total, the waterborne coatings system (waterborne hybrid epoxy-polysiloxane etch primer with hybrid polyurethane-epoxy waterborne primer layer) had comparable or improved properties compared to the conventional solvent borne coatings system. Thus, the disclosed hybrid polyurethane-epoxy waterborne primer coating has a lower amount of VOCs while providing similar or better properties than conventional solvent borne coatings systems.

The following are non-limiting examples of some embodiments of the present invention:
Embodiment 1. A 3K primer coating composition, comprising:
   a waterborne epoxy resin dispersion;
   a polyurethane dispersion; and
   a curing component comprising a non-isocyanate crosslinker component, wherein the non-isocyanate crosslinker component comprises a carbodiimide compound, a polycarbodiimide compound, an aziridine compound, and a polyaziridine compound, or a combination thereof.
Embodiment 2. The 3K primer coating composition of Embodiment 1, wherein the curing component further comprises an isocyanate.
Embodiment 3. The 3K primer coating composition of one of Embodiments 1 or 2, wherein the polyurethane dispersion comprises carboxyl groups.
Embodiment 4. The 3K primer coating composition of any one of Embodiments 1 to 3, wherein the network comprises crosslinks between the crosslinked epoxy resin regions and the crosslinked polyurethane resin regions.
Embodiment 5. The 3K primer coating composition of any one of Embodiments 1 to 4, wherein the epoxy resin dispersion comprises hydroxyl groups.
Embodiment 6. The 3K primer coating composition of any one of Embodiments 1 to 5, wherein the polyurethane dispersion and the epoxy resin dispersion are waterborne.
Embodiment 7. The 3K primer coating composition of any one of Embodiments 1 to 6, wherein the polyurethane dispersion further comprises quaternary ammonium salt functional groups.
Embodiment 8. A primer coating comprising:
   a network of crosslinked epoxy resin regions and crosslinked polyurethane resin regions,
   wherein the crosslinked epoxy resin regions comprise units from an epoxy resin dispersion and an isocyanate, and
   wherein the crosslinked polyurethane resin regions comprise units from a polyurethane dispersion and a non-isocyanate crosslinker component.
Embodiment 9. The primer coating of Embodiment 8, wherein the non-isocyanate crosslinker component comprises a carbodiimide compound, a polycarbodiimide compound, an aziridine compound, and a polyaziridine compound, or a combination thereof.
Embodiment 10. The primer coating of one of Embodiments 8 or 9, wherein the epoxy resin dispersion comprises hydroxyl groups.
Embodiment 11. The primer coating of any one of Embodiments 8 to 10, wherein the network comprises crosslinks between the crosslinked epoxy resin regions and the crosslinked polyurethane resin regions.
Embodiment 12. The primer coating of any one of Embodiments 8 to 11, wherein the isocyanate is an aliphatic isocyanate.
Embodiment 13. The primer coating of any one of Embodiments 8 to 12, wherein polyurethane dispersion and the epoxy resin dispersion are waterborne.
Embodiment 14. The primer coating of any one of Embodiments 8 to 13, wherein the polyurethane dispersion further comprises quaternary ammonium salt functional groups.
Embodiment 15. The primer coating of any one of Embodiments 8 to 14, wherein the polyurethane dispersion further comprises carboxyl groups.
Embodiment 16. The primer coating of any one of Embodiments 8 to 15, wherein the units of the crosslinked polyurethane resin regions and the units of the crosslinked epoxy resin regions have an equivalent ratio of carbodiimide groups to carboxyl groups between 2 and 7.
Embodiment 17. A coatings system comprising:
   an etch primer coating;
   the primer coating of any one of Embodiments 8 to 16 arranged over the etch primer coating; and
   optionally one or more additional coatings arranged over the primer coating.
Embodiment 18. The coatings system of Embodiment 17, wherein the etch primer coating and the primer coating are waterborne.
Embodiment 19. The coatings system of one of Embodiments 19 or 17, wherein the etch primer coating comprises a hybrid epoxy-polysiloxane waterborne etch primer.
Embodiment 20. The coatings system of any one of Embodiments 17 to 19, wherein regions of the etch primer coating are crosslinked to regions of the primer coating at an interface between the etch primer coating and the primer coating.
Embodiment 21. The coatings system of any one of Embodiments 17 to 20, wherein the etch primer coating comprises unreacted amine groups configured to react with the epoxy resin dispersion of the primer coating at the interface when the etch primer coating receives the primer coating.
Embodiment 22. The coatings system of any one of Embodiments 17 to 21, wherein the system is configured to be arranged over a substrate.
Embodiment 23. The coatings system of Embodiment 22, wherein the substrate comprises a metal.
Embodiment 24. A method of forming a primer coating comprising: forming a waterborne polyurethane dispersion comprising carboxyl groups; forming a waterborne epoxy resin dispersion; and combining and mixing the waterborne polyurethane dispersion, the waterborne epoxy resin dispersion, and a polycarbodiimide.
Embodiment 25. The method of Embodiment 24, wherein the curing component further comprises an isocyanate.
Embodiment 26. The method of one of Embodiments 24 or 25, wherein the waterborne epoxy resin dispersion comprises epoxy latex.
Embodiment 27. The method of any one of Embodiments 24 to 26, wherein the waterborne epoxy resin dispersion comprises hydroxyl groups.
Embodiment 28. The method of any one of Embodiments 24 to 27, wherein the primer coating comprises a network of crosslinked epoxy resin regions and crosslinked polyurethane resin regions.
Embodiment 29. The method of any one of Embodiments 24 to 28, further comprising:
   applying the mixture of the waterborne polyurethane dispersion, the waterborne epoxy resin dispersion, the isocyanate, and the polycarbodiimide to a substrate; and
   curing the mixture to form the primer coating on the substrate, wherein the mixture cures as the isocyanate reacts with the waterborne epoxy resin dispersion and the polycarbodiimide reacts with the waterborne polyurethane dispersion.
Embodiment 30. The method of Embodiment 29, wherein the mixture is applied directly to the substrate.
Embodiment 31. The method of one of Embodiment 29 or 30, wherein the substrate is metal, plastic, glass, composites, ceramic or a combination thereof.
Embodiment 32. The method of any one of Embodiments 29 to 31, wherein the substrate is a metal, and wherein a waterborne etch primer coating is applied to the substrate before the mixture is applied to the substrate such that the mixture is applied directly on the waterborne etch primer coating over the substrate.
Embodiment 33. The method of Embodiment 32, wherein after curing the mixture to form the primer coating, regions of the waterborne etch primer coating are crosslinked to regions of the primer coating at an interface between the waterborne etch primer coating and the primer coating.
Embodiment 34. The method of one of Embodiments 31 or 32, wherein the waterborne etch primer coating is formed from a hybrid waterborne epoxy-polysiloxane primer.
Embodiment 35. The method of Embodiment 34, wherein the hybrid waterborne epoxy-polysiloxane primer comprises amine groups, and wherein when the mixture is applied to hybrid waterborne epoxy-polysiloxane primer, the amine groups of the waterborne epoxy-polysiloxane primer react with the waterborne epoxy resin dispersion.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several embodiments, such feature may be combined with one or more other features of the other embodiments as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A 3K primer coating composition, comprising:
a waterborne epoxy resin dispersion;
a polyurethane dispersion; and
a curing component comprising a non-isocyanate crosslinker component, wherein the non-isocyanate crosslinker component comprises a carbodiimide compound, a polycarbodiimide compound, an aziridine compound, and a polyaziridine compound, or a combination thereof.

2. The 3K primer coating composition of claim 1, wherein the curing component further comprises an isocyanate.

3. The 3K primer coating composition of claim 1, wherein the polyurethane dispersion comprises carboxyl groups.

4. The 3K primer coating composition of claim 1, wherein the network comprises crosslinks between the crosslinked epoxy resin regions and the crosslinked polyurethane resin regions.

5. The 3K primer coating composition of claim 1, wherein the epoxy resin dispersion comprises hydroxyl groups.

6. The 3K primer coating composition of claim 1, wherein the polyurethane dispersion and the epoxy resin dispersion are waterborne.

7. The 3K primer coating composition of claim 1, wherein the polyurethane dispersion further comprises quaternary ammonium salt functional groups.

8. A primer coating comprising:
a network of crosslinked epoxy resin regions and crosslinked polyurethane resin regions,
wherein the crosslinked epoxy resin regions comprise units from an epoxy resin dispersion and an isocyanate, and
wherein the crosslinked polyurethane resin regions comprise units from a polyurethane dispersion and a non-isocyanate crosslinker component.

9. The primer coating of claim 8, wherein the non-isocyanate crosslinker component comprises a carbodiimide compound, a polycarbodiimide compound, an aziridine compound, and a polyaziridine compound, or a combination thereof.

10. The primer coating of claim 8, wherein the network comprises crosslinks between the crosslinked epoxy resin regions and the crosslinked polyurethane resin regions.

11. The primer coating of claim 8, wherein polyurethane dispersion and the epoxy resin dispersion are waterborne.

12. The primer coating of claim 8, wherein the polyurethane dispersion further comprises quaternary ammonium salt functional groups.

13. The primer coating of claim 8, wherein the polyurethane dispersion further comprises carboxyl groups.

14. A coatings system comprising:
an etch primer coating;
the primer coating of claim 8 arranged over the etch primer coating; and
optionally one or more additional coatings arranged over the primer coating.

15. The coatings system of claim 14, wherein the etch primer coating and the primer coating are waterborne.

16. The coatings system of claim 14, wherein the etch primer coating comprises a hybrid epoxy-polysiloxane waterborne etch primer.

17. The coatings system of claim 14, wherein regions of the etch primer coating are crosslinked to regions of the primer coating at an interface between the etch primer coating and the primer coating.

18. The coatings system of claim 14, wherein the etch primer coating comprises unreacted amine groups configured to react with the epoxy resin dispersion of the primer coating at the interface when the etch primer coating receives the primer coating.

19. A method of forming a primer coating comprising:
forming a waterborne polyurethane dispersion comprising carboxyl groups;
forming a waterborne epoxy resin dispersion; and
combining and mixing the waterborne polyurethane dispersion, the waterborne epoxy resin dispersion, and a polycarbodiimide.

20. The method of claim 19, wherein the curing component further comprises an isocyanate.

21. The method of claim 19, wherein the primer coating comprises a network of crosslinked epoxy resin regions and crosslinked polyurethane resin regions.

22. The method of claim 19, further comprising:
applying the mixture of the waterborne polyurethane dispersion, the waterborne epoxy resin dispersion, the isocyanate, and the polycarbodiimide to a substrate; and
curing the mixture to form the primer coating on the substrate, wherein the mixture cures as the isocyanate reacts with the waterborne epoxy resin dispersion and the polycarbodiimide reacts with the waterborne polyurethane dispersion.

23. The method of claim 22, wherein the mixture is applied directly to the substrate.
